(19) United States
(12) Patent Application Publication
(10) Pub. No.: US 2023/0384421 A1
(43) Pub. Date: Nov. 30, 2023

(54) METHOD AND DEVICE FOR GENERATING AN OPTIMIZED 3D POINT CLOUD OF AN ELONGATE OBJECT FROM IMAGES GENERATED BY A MULTIPATH SYNTHETIC-APERTURE RADAR

(71) Applicant: MBDA FRANCE, Le Plessis-Robinson (FR)

(72) Inventor: César LACROIX, Le Plessis-Robinson (FR)

(21) Appl. No.: 18/266,215

(22) PCT Filed: Nov. 24, 2021
(86) PCT No.: PCT/FR2021/052088

§ 371 Date: Jun. 8, 2023

(30) Foreign Application Priority Data
Dec. 9, 2020 (FR) FR2012824

(51) Int. Cl. G01S 7/41; G01S 13/90; G01S 7/40

(52) U.S. Cl. CPC G01S 7/417; G01S 13/883; G01S 7/4026; G01S 13/9092

(57) ABSTRACT

The device (1) comprises a thresholding unit (6) for performing adaptive thresholding so as to generate a segmentation mask for images generated by a synthetic-aperture radar (2) and subjected beforehand to interferometry processing, a processing unit (7) for accumulating measurements for each of the segmentation masks so as to generate at least one accumulator and one energy profile, an alignment unit (8) for calibrating the accumulators and the energy profiles so as to obtain calibrated accumulators and calibrated energy profiles, a computing unit (9) for computing a unitary cloud for each of the segmentation masks, from the calibrated accumulators and the calibrated energy profiles, and a fusion unit (10) for fusing the unitary clouds so as to obtain said optimized 3D cloud.

### TECHNICAL FIELD

The present invention relates to a method and a device for generating an optimised 3D point cloud depicting an elongate object, from a sequence of images of the environment of the elongate object generated by a synthetic aperture radar provided with a plurality of paths.

### BACKGROUND

The purpose of the present invention is therefore to generate an optimised 3D point cloud depicting an elongate object (i.e. an object that is longer than it is wide), whether immobile or mobile, for example a ship at sea. This optimised 3D cloud can then be used to accurately identify the detected elongate object. Other applications are also possible, as detailed below.

Although not exclusively, the present invention is particularly applicable to the military field. In particular, it can be used to carry out a robust radar-based recognition and identification of ships, including enemy ships, as part of a detection, recognition and identification function.

In particular, it can be mounted on a long-range missile to carry out an autonomous in-flight identification of a target to be engaged, for example a naval target for the terminal guidance.

In such applications, the recognition and the identification must be able to be carried out on a mobile object and must be able to discriminate between two or more nearby objects, whether mobile or not.

In addition, the recognition and the identification must be carried out with signals that have a low signal-to-noise ratio (SNR), a short integration time and the risk of glint effects.

A recognition and an identification that meets these conditions is very difficult to implement.

### DESCRIPTION OF THE INVENTION

The object of the present invention is to propose a method allowing for meeting the above conditions. To this end, it concerns a method for generating an optimised 3D point cloud illustrating an elongate object, from a sequence of images of the environment of the elongate object generated by a synthetic aperture radar provided with a plurality of paths, each of the images referred to as multipath generated by the synthetic aperture radar comprising one synthetic aperture image per path, the multipath images being subjected to an interferometric processing allowing to obtain, for each multipath image, a sum path image and angular maps in azimuth and in elevation.

According to the invention, said method comprises at least the following steps:
a thresholding step consisting in carrying out an adaptive thresholding so as to generate a segmentation mask for each of the sum path images;
a processing step consisting in carrying out, for each of said segmentation masks, an accumulation of measurements so as to generate, for each of said segmentation masks, at least one accumulator and an energy profile;
an alignment step consisting in calibrating the accumulators and the energy profiles so as to obtain accumulators referred to as calibrated and energy profiles referred to as calibrated;
a computing step consisting in computing, for each of said segmentation masks, from the calibrated accumulators and the calibrated energy profiles obtained in the alignment step, a unitary cloud via a unitary merging; and
a merging step consisting in merging the unitary clouds, so as to obtain said optimised 3D cloud.

Thus, thanks to the invention, said method carries out in particular the merging of several unitary 3D clouds to smooth out the unsteadiness and reduce the 3D noise, as specified below.

In the context of the present invention:
a SAR image referred to as multipath is composed of an SAR image per path. For example, a multipath SAR image with N reception paths is composed of N SAR images. Each image of index i (i ranging from 1 to N) is generated with the corresponding index reception path; and
the interferometric processing transforms the multipath image and provides an image referred to as sum path and two angular maps of equal size defining the azimuth and elevation angles for each pixel of the sum path image.

In a preferred embodiment, the thresholding step comprises:
a sub-step consisting in comparing the level of the intensity of each pixel to at least one minimum intensity threshold; and
a sub-step consisting in retaining only those pixels whose intensity is greater than this minimum intensity threshold in the segmentation mask which is a binary map of the same size as the sum path image in which the retained pixels are 1 and the non-retained pixels are 0.

Advantageously, in the thresholding step, a sub-step consisting in carrying out a morphological filtering is also carried out.

Furthermore, in a preferred embodiment, the processing step comprises the following sequence of successive sub-steps, which are implemented for each segmentation mask:
a sub-step consisting in implementing a principal component analysis to estimate a length axis of the elongate object, representing an axis referred to as principal;
a sub-step consisting in computing at least one accumulator (or accumulation dictionary or pixel dictionary) sampled along the principal axis, the accumulator representing a one-dimensional grid comprising a plurality of cells, each of said cells containing the pixels of the segmentation mask that are located at the level of the cell; and
a sub-step consisting in computing at least one energy profile from the accumulator, the energy profile representing a one-dimensional vector whose values depend on the intensities (or reflectivities or energies) of the pixels of each of the cells of the accumulator, and correspond for example to the average reflectivity or the sum of the reflectivities of each of the cells of the accumulator.

Thus, through this processing step, whereby the transverse axis (containing little information in the case of an imaged elongate object) is sacrificed and the longitudinal information (of the imaged elongate object) is maximised along said principal axis, the “glint” effect is reduced and the additive noise is smoothed. In addition, the energy profile will allow the accumulators from each segmentation mask to be calibrated, as described below.

Furthermore, advantageously, the alignment step comprises the following sequence of successive sub-steps, which are implemented for each segmentation mask:
a sub-step consisting in making a correlation of the profile or profiles to estimate potential translations and optimal sampling; and
a sub-step consisting in making a completion with empty cells and zero energy components of previous profiles or of the next profile.

This alignment step carries out the mapping of the measurements in the time sequence. It aims to calibrate the energy profiles for all the measurements in the time sequence. It is fundamental for mapping the accumulators and the energy profiles of the moment of the time sequence.

Furthermore, in a preferred embodiment, the computing step consists, for each of the segmentation masks, in defining a unitary cloud whose number of points is equal to the number of cells of the calibrated accumulator, and comprises the following sequence of successive sub-steps, which are implemented for each cell of the calibrated accumulator:
a sub-step consisting in computing an assembly of components referred to as individual of each of the pixels in the cell;
a sub-step consisting in computing an assembly of components referred to as global for each of the cells, from the assembly of the individual components of the cell; and
a sub-step consisting in computing a level component, based at least on the value of the energy profile at the cell.

Furthermore, in a particular embodiment, the computing of the level component takes into account, in addition to the value of the energy profile at the cell, the quadratic sum of the standard deviations computed on the 3D relocated pixels contained in the cell.

This computing step carrying out mergers referred to as unitary allows for:
smoothing the radiometric content (construction-averaged energy profile) over a neighbourhood of the signature, thereby generating a spatial radiometric smoothing; and
smoothing the geometric content (average of the 3D positions in each accumulator cell) over a neighbourhood of the signature, which generates a reduction of the 3D spatial noise induced by the angular noise of the interferometric measurement (itself induced by the thermal noise and the glint effect).

In addition, advantageously, the merging step comprises:
a sub-step consisting, for each unitary cloud, in carrying out the following operations:
   centring the global components of the unitary cloud;
   implementing a principal component analysis to estimate the longitudinal axis of the unitary cloud; and
   generating a rotation of the unitary cloud to orient it along a predefined axis;
a sub-step consisting in computing the statistical average, point by point, of the global components and of the level component of the assembly of the unitary clouds to obtain said optimised 3D cloud.

This merging step allows:
to smooth the radiometric content over a temporal neighbourhood of the signature. Thus, the radiometric content is less fluctuating with the aspect angle; and
to smooth the geometric content over a temporal neighbourhood of the signature. In this way, a further reduction of the 3D spatial noise induced by the angular noise of the interferometric measurement (itself induced by thermal noise and the glint effect) is achieved.

Advantageously, the merging step also comprises a sub-step of filtering outliers, the smoothing of which is not sufficient, thus allowing for optimising the method.

The present invention concerns a device for generating an optimised 3D point cloud illustrating an elongate object, from a sequence of images of the environment of the elongate object generated by a synthetic aperture radar provided with a plurality of paths, each of the images referred to as multipath generated by the synthetic aperture radar comprising a synthetic aperture image per path, the multipath images being subjected to an interferometric processing allowing to obtain, for each multipath image, a sum path image and angular maps in azimuth and in elevation.

According to the invention, said device comprises at least:
a thresholding unit configured to carry out an adaptive thresholding so as to generate a segmentation mask for each of the sum path images;
a processing unit configured to carry out, for each of said segmentation masks, an accumulation of measurements so as to generate, for each of said segmentation masks, at least one accumulator and an energy profile;
an alignment unit configured to calibrate the accumulators and the energy profiles so as to obtain accumulators referred to as calibrated and energy profiles referred to as calibrated;
a computing unit configured to compute, for each of said segmentation masks, from the calibrated accumulators and the calibrated energy profiles, a unitary cloud via a unitary merging; and
a merging unit configured to merge the unitary clouds, so as to obtain said optimised 3D cloud.

The device and/or the method, as described above, can be implemented in many applications, in particular by being integrated in different systems for the use and the processing of real or simulated radar images.

The present invention also relates to a system for recognising and identifying a target representing an elongate object, in particular a ship, said system comprising at least:
a synthetic aperture radar with a plurality of paths and capable of generating images of the environment of the target (elongate);
a processing unit configured to process the images generated by the synthetic aperture radar so as to derive data referred to as detection;
a database containing data referred to as target reference; and
a comparison unit configured to compare the detection data with reference data from the database so that a (elongate) target can be recognised and identified.

According to the invention, the processing unit of this system comprises a device as described above, for generating an optimised 3D point cloud illustrating an elongate object and a unit carrying out an interferometric processing.

Advantageously, said system also comprises a decision unit using the data transmitted by the comparison unit and additional data to make a decision.

The present invention further relates to a system for generating a trained metric and a reference base related to at least one type of elongate object, in particular a ship, said system comprising at least:
a base of object models and at least of elongate objects;
a multipath synthetic aperture radar scene generator, linked to the object model base and capable of simulating multipath SAR images;
a processing unit configured to process the images generated by the scene generator to create a point cloud depicting an elongate object and to provide data;
a creation unit for creating a reference base, linked to the object model base and capable of creating a reference base; and
a learning unit configured to carry out a learning from the data (e.g. the optimised cloud, or a data that shapes the latter, such as an image recomputed on this cloud) received from the processing unit and from the reference base and to provide the trained metric and the reference base.

According to the invention, the processing unit comprises a device as described above, for generating an optimised 3D point cloud illustrating an elongate object and a unit carrying out an interferometric processing beforehand.

### BRIEF DESCRIPTION OF FIGURES

Further advantages and characteristics will become apparent from the following description of several embodiments of the invention, given as non-limiting examples, with particular reference to the attached figures. In these figures, identical references designate similar elements.

FIG. 1 is a block diagram of a device according to a particular embodiment of the invention.

FIG. 2 illustrates a particular application of the invention.

FIGS. 3A, 3B and 3C show schematically different 3D clouds.

FIGS. 4A, 4B and 4C show schematically different accumulators.

FIG. 5 is a block diagram of a method according to a particular embodiment of the invention.

FIGS. 6A and 6B show schematically an alignment of pixels in the image and the creation of an accumulator.

FIGS. 7A and 7B illustrate energy profiles before and after a calibration, respectively.

FIGS. 8A, 8B, 8C and 8D allow to show a unitary cloud computing step.

FIGS. 9A, 9B, 9C, 9D, 9E and 9F allow to show a unitary cloud merging step to obtain an optimised 3D cloud.

FIG. 10 is a block diagram of a system for recognising and identifying a target representing an elongate object.

FIG. 11 is a block diagram of a system for generating a trained metric and a reference base.

### DETAILED DESCRIPTION

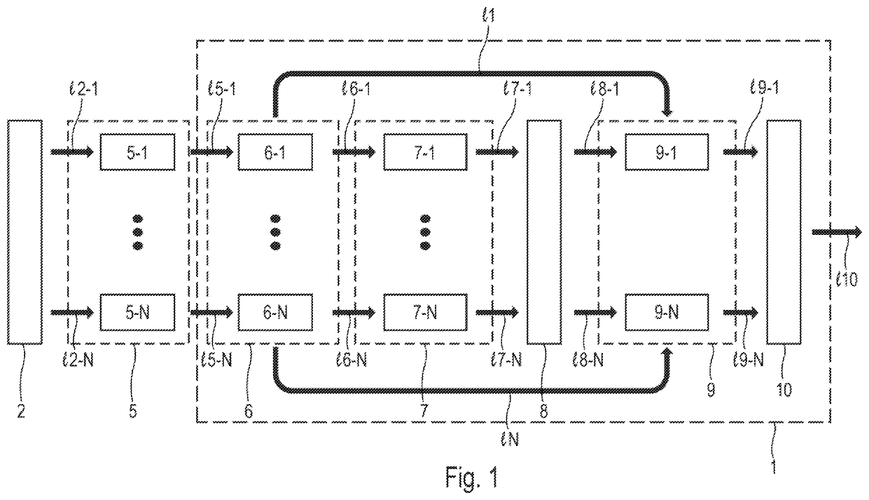

The device 1 shown schematically in FIG. 1 and allowing to illustrate the invention is intended to generate a 3D (three-dimensional, i.e. in space) cloud of points illustrating an elongate (or elongated or oblong) object 3 along a longitudinal axis, i.e. an object that is longer than it is wide.

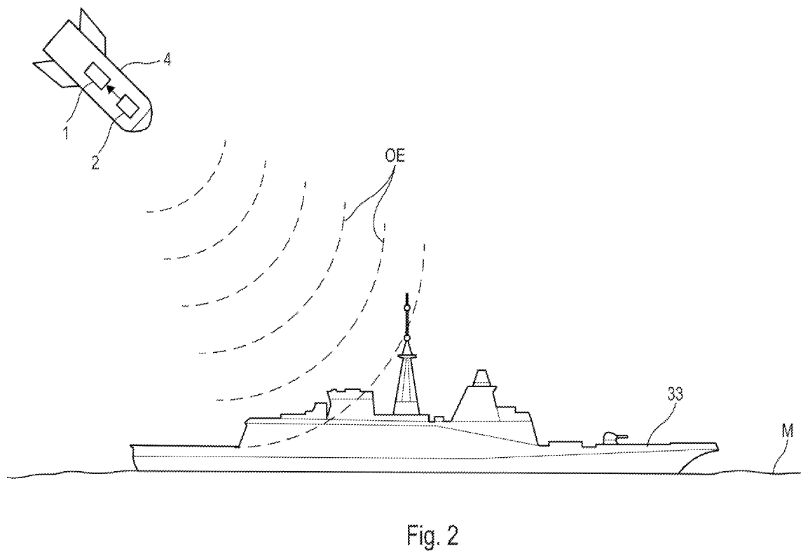

The device 1 is designed to generate the optimised 3D cloud from a sequence of radar-generated images of the environment of the elongate object. This radar (hereinafter “SAR radar 2”) is a multipath synthetic aperture radar (SAR) (i.e. with a plurality of paths). Preferably, the SAR radar 2 has one transmission path and several reception paths (to implement a radar interferometry). By way of illustration, FIG. 2 shows a very schematic representation of the electromagnetic waves OE emitted by the transmission path of the SAR radar 2.

In general, a SAR image generated by a SAR radar (and thus an image generated by the SAR radar 2 in particular) has the following advantages:
it enhances the signal in noise;
it separates the different possible contributors.

More specifically, as the integration time is increased, the resolution and the SNR are increased.

In addition, a multipath SAR radar allows, through an interferometric processing, to relocate in 3D with:
a distance measurement; and
two angular maps in elevation and in azimuth (from the interferometric processing).

The angular information is first order insensitive to the motion of the elongate object 3 and is noisy in proportion to the thermal noise of the image. It is also generally sensitive to the presence of several contributors in the pixel (fluctuation of the effect referred to as “glint”). The device 1 will in particular allow to remedy the two disadvantages mentioned above (angular uncertainty linked to the “glint” effect and to the thermal noise).

Of course, within the scope of the present invention, the device 1 can be used to process images of other types of elongate objects, whether mobile or immobile, for example military land or sea craft.

In addition, the SAR radar 2 can be mounted on other flying machines, for example on an observation aircraft.

In the example described below, the elongate object 3 is a ship 33 travelling on a sea M (or other body of water). Furthermore, in the particular example shown in FIG. 2, the device 1 and the radar 2 are mounted on a missile 4 which is heading towards the ship 33, in this case an enemy ship, to neutralise it.

In the context of the present invention, each of the images generated by the SAR radar 2 (of multipath type) comprises one SAR image per path.

In the example shown in FIG. 1, the SAR radar is considered to be transmitting a sequence of N images, i.e. 1 to N, transmitted via links l2-1 to l2-N respectively.

To facilitate the understanding of the processing implemented by the units 5, 6, 7 and 9 specified below, the operations implemented by each of the N multipath images are shown separately in FIG. 1, representing N modules, namely 5-1 to 5-N, 6-1 to 6-N, 7-1 to 7-N, and 9-1 to 9-N, although in each of these units, the corresponding unit carries out the same processing for the N images.

The device 1 comprises the following units, as shown in FIG. 1:
a thresholding unit 6 configured to carry out an adaptive thresholding so as to generate a segmentation mask for each of N sum path images received via links l5-1 to l5-N;
a processing unit 7 configured to carry out, for each of the segmentation masks, received via links l6-1 to l6-N from the thresholding unit 6, an accumulation of measurements so as to generate, for each of these segmentation masks, at least one accumulator and an energy profile;
an alignment unit 8 configured to calibrate the accumulators and the energy profiles (received via links l7-1 to l7-N from the processing unit 7) so as to obtain accumulators referred to as calibrated and energy profiles referred to as calibrated;
a computing unit 9 configured to compute, for each of the segmentation masks, a unitary cloud via a unitary merging, from the calibrated accumulators and calibrated energy profiles generated by the alignment unit 8 and received via links l8-1 to l8-N from the alignment unit 8, as well as thresholded angular (in elevation and in azimuth) maps and distance indexes (received via links l1 to lN from the thresholding unit 6); and
a merging unit 10 configured to merge the unitary clouds, received via links l9-1 to l9-N from the computing unit 9, so as to generate said optimised 3D cloud. This optimised 3D cloud can be transmitted via a link l10 to a user device or system (not shown).

A unit 5 is also provided for subjecting the images generated by the SAR radar 2 (received via the links l21 to l2N) to an interferometric processing, prior to their transmission (via links l5-1 to l5-N) to the thresholding unit 6. This interferometric processing forms, for each multipath image, a sum path image and two associated azimuth and elevation angular maps.

This unit 5 may for example be part of an assembly or module that also comprises the SAR radar 2.

The characteristics and the processing carried out by the different units of the device 1 are specified below when describing a method PR implemented by the device 1.

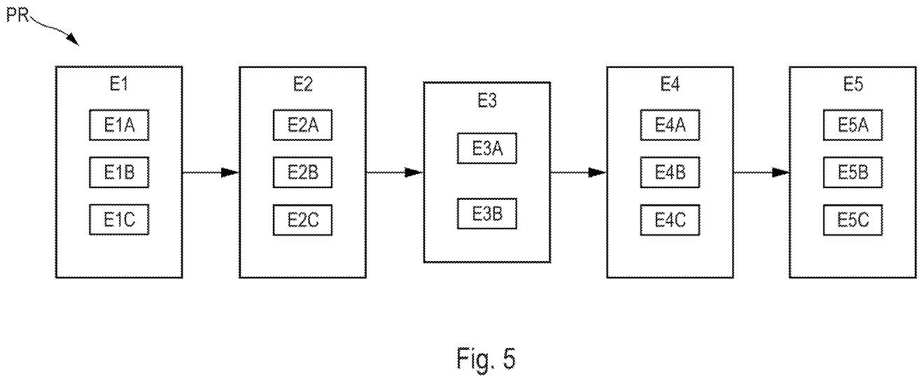

The device 1, as described above, implements the method PR shown in FIG. 5, to generate an optimised 3D point cloud illustrating an elongate object 3 (i.e. the ship 33 in the following description). The method PR allows to form the optimised 3D cloud from a sequence of SAR images of the environment of the elongate object 3 generated by the SAR radar 2 and processed by the interferometry (unit 5), these images comprising pixels relating to the elongate object 3.

As mentioned below, the method PR will carry out the merging of several 3D clouds referred to as unitary to smooth out the unsteadiness and reduce the 3D noise.

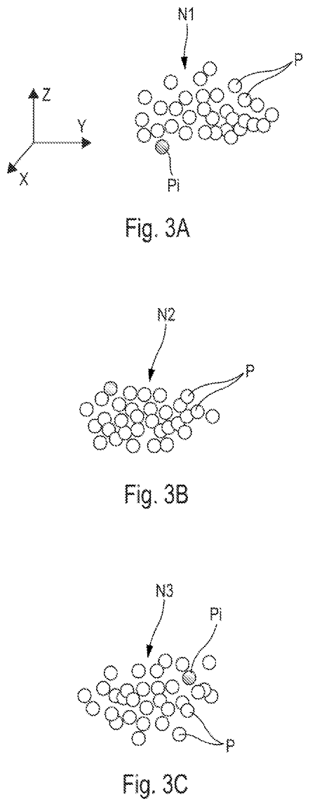

By way of illustration, three different clouds N1, N2 and N3 of points P are shown in FIGS. 3A, 3B and 3D in a three-dimensional space (illustrated by an X, Y and Z axis reference frame).

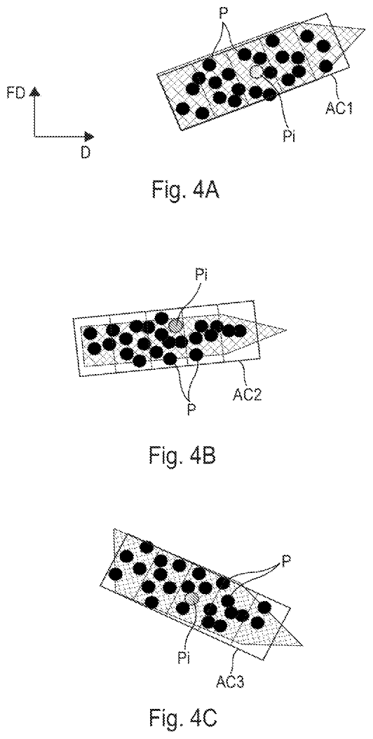

In general, the method PR involves mapping assemblies of pixels between the SAR images, for example the point (or pixel) Pi shown in FIGS. 4A, 4B and 4C, and a merging of the assemblies into 3D, as shown below. It will not be possible to map each point Pi but assemblies of pixels. In 3D space, only the merging of the assemblies will be kept, each of which will be summarised in a single point. By way of illustration, FIGS. 4A, 4B and 4C show the mapping carried out by the device 1 (in particular via the generation of accumulators A1, A2 and A3 as specified below) in an image space (illustrated by a reference frame comprising a distance axis D and a Doppler frequency axis FD).

The images generated by the SAR radar 2 are subjected to an interferometric processing in a step prior to the implementation of the method PR before being used in a thresholding step E1 (FIG. 5) of the method PR. The interferometric processing is carried out by the unit 5 (FIG. 1). This interferometric processing allows to obtain a sum path image and angular maps in azimuth and in elevation from the multipath images.

The multipath images (SAR) are generated by the SAR radar 2 in a given time sequence. The interferometric processing is implemented by the unit 5, depending on the reception architecture (number of paths, antenna geometry) of the SAR radar 2.

For example, in the case of a SAR radar architecture with four reception quadrants (or paths), it can be envisaged that the signal is transmitted by one path and the four reception paths acquire the return signal. The four images per path are then formed by means of the SAR processing. To carry out the interferometry, the “Monopulse” algorithm can be used. Originally, the “Monopulse” algorithm got its name from its use of a single transmitted pulse as a return echo. In the case of images, the algorithm is applied to each of the distance and Doppler pixels. Different signals (sum and difference) are created through the different paths. In this case, the ratio of the difference path to the sum path (two ratios for the two axes) allows the difference in speed to be determined, which is the basis of the distance measurement information.

After this interferometric processing, we obtain, for each (measurement) time of the time sequence:
a sum path image, representing a coherent sum (in C) of the SAR images from each of the reception paths of the SAR radar 2; and
an angular map in azimuth and in elevation. Such an angular map is of the same size as the sum path image, with pixel levels corresponding to the elevation angles El and to the azimuth angles Az respectively.

This implementation has several advantages, in particular:
the only condition imposed by the method PR on the interferometric processing is to provide two estimated angles (azimuth and elevation) per pixel of the SAR image, regardless of the architecture of the multipath SAR radar used to obtain these data;
the image interferometry is robust, to first order, to distortions induced in the SAR image by the mobile objects; and
the time sequence can be carried out in a short time interval (with a compact acquisition in time) for optimality of the future mapping, as specified below.

The method PR comprises, as shown in FIG. 5, a sequence of steps E1 to E5 comprising:
a thresholding step E1, implemented by the thresholding unit 6 (FIG. 1), consisting in carrying out an adaptive thresholding so as to generate a segmentation mask for each of the sum path images (per multipath image);
a processing step E2, implemented by the processing unit 7, consisting in carrying out, for each of the segmentation masks generated in the thresholding step E1, an accumulation of measurements so as to generate, for each of these segmentation masks, at least one accumulator and an energy profile;
an alignment step E3, implemented by the alignment unit 8, consisting in aligning (or calibrating or re-phasing) the accumulators and the energy profiles (generated in the processing step E2) so as to obtain accumulators referred to as calibrated and energy profiles referred to as calibrated;
a computing step E4, implemented by the computing unit 9, consisting in computing, for each of the segmentation masks, from the calibrated accumulators and the calibrated energy profiles obtained in the alignment step E3, a unitary cloud via a first merging referred to as unitary; and
a merging step E5, implemented by the merging unit 10, consisting in merging (via a terminal merge) the unitary clouds obtained in the computing step E4, so as to generate said optimised 3D cloud.

In a preferred embodiment, the thresholding step E1 comprises, as shown in FIG. 5:
a sub-step E1A consisting in comparing the level of the intensity of each pixel to at least one minimum intensity threshold, and preferably to both a minimum intensity threshold and a maximum intensity threshold; and
a sub-step E1B consisting in retaining in the segmentation mask only those pixels whose intensity is greater than this minimum intensity threshold, or in the case of a comparison at both a minimum intensity threshold and a maximum intensity threshold, retaining only those pixels whose intensity is between these thresholds (i.e. less than the maximum intensity threshold and greater than the minimum intensity threshold).

The resulting segmentation mask is a binary map of the same size as the sum path image, in which the pixels retained in sub-step E1B (following the comparison implemented in sub-step E1A) are 1 and the pixels not retained (following the comparison) are 0.

Sub-step E1B consists in redefining the angular maps by keeping only the points present in the segmentation mask.

In a particular embodiment, sub-step E1A consist in:
computing an upper quantile on the intensity of the sum path SAR image (modulus squared of the image) to define a maximum threshold to be retained in the segmentation (for example, a 100% quantile for a thresholding to the maximum peak in the image);
computing a low threshold via a chosen dynamic range (in dB), for example 40 dB dynamic range; and
carrying out a thresholding by comparing each (pixel) level with the high and low thresholds in order to obtain a binary segmentation mask of the selected points (value 0 for the pixels below the low threshold and value 1 for the pixels between the low threshold and the high threshold).

Furthermore, in a particular embodiment, the thresholding step E1 also comprises a sub-step E1C, implemented after sub-step E1B, consisting in carrying out a morphological filtering (morphological opening operation), to eliminate the small isolated elements in the signature (corresponding for example to false alarms on thermal noise).

This thresholding step E1 has the following advantages in particular:
the high dynamic range of the signature comprises the most stable and majority points in the radiometry of the object; and
the high dynamic range (points with the highest SNR ratios) is the least affected by thermal noise.

The thresholding step E1 thus allows to retain only the strongest contributors of each SAR signature and thus presenting the best signal to noise ratio (or SNR). The thresholding step E1 provides a segmentation mask for each of the N instants of the image sequence.

Furthermore, the processing step E2 which follows the thresholding step E1 aims to cut the signature of the object along a grid in its length axis (or longitudinal axis), known as the principal axis AP. The cross-sectional dimension will be lost in favour of an accumulation of measures allowing to reduce the 3D noise downstream, as detailed below.

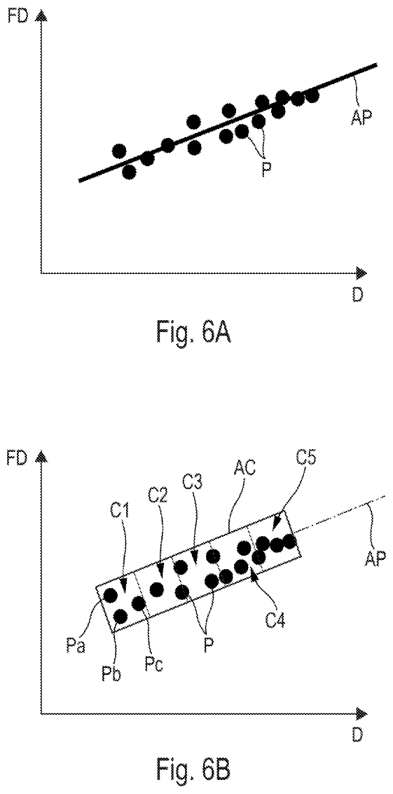

FIG. 6A illustrates in the image space (distance D and Doppler frequency FD) a segmentation mask (comprising the pixels P) and its principal axis AP.

The processing step E2 generates, for each segmentation mask:
an accumulator AC (or accumulation dictionary or pixel dictionary) representing a one-dimensional grid comprising a plurality of cells (longitudinal and transverse size parameter) such as the cells C1, C2, C3, C4 and C5 of the accumulator AC of FIG. 6B. Each of the cells C1 to C5 contains the pixels P of the segmentation mask which are located at the level of the cell as illustrated for the pixels Pa, Pb and Pc of the cell C1 in FIG. 6B; and
an energy profile representing a one-dimensional vector whose values L1 to L5 depend on the intensities of the pixels of each of the cells C1 to C5 of the accumulator AC, as specified below.

To this end, in a preferred embodiment, the processing step E2 comprises the following sequence of successive sub-steps E2A to E2C, which are implemented for each segmentation mask:
the sub-step E2A consisting in implementing a principal component analysis (hereafter referred to as “PCA analysis”) to estimate a length axis of the object, representing the principal axis AP (FIG. 6A). This PCA analysis is carried out on the image coordinates of the points selected in the segmentation mask. A weighting of the PCA analysis can be considered in particular by the levels of the points, for example via an average of the moduli or squared moduli (choice of amplitude or choice of intensity) of the reflectivities of the segmented pixels;
the sub-step E2B consisting in computing one or more accumulators AC (or accumulation dictionaries or pixel dictionaries) depending on the number of samplings considered. The accumulator or the accumulators AC are sampled along the principal axis AP (FIG. 6B), the accumulator AC thus representing a one-dimensional grid comprising a plurality of cells C1 to C5. Each of the cells C1 to C5 contains the pixels P of the segmentation mask which are located at the level of the cell. The closer the time sequence of the SAR images, the more similar the images become, and thus the angle of presentation of the elongate object slowly changes. This allows to avoid directional errors in the definition of the accumulators by checking that the orientation of the main axis does not fluctuate abruptly by an angle close to 180°; and
the sub-step E2C consisting in determining one or more energy profiles from the accumulator or the accumulators AC, the energy profile thus representing a one-dimensional vector whose values depend on the pixel intensities of each of the cells C1 to C5 of the accumulator AC.

To compute the accumulator or the accumulators (in sub-step E2B), a common assembly of cell size values (in pixels) is set. The minimum and maximum coordinates of the points are computed on the main axis AP. The cells are then defined by a range data (maximum point-minimum point) and the cell size. In each cell, the pixels of the mask are referenced in the SAR signature. This means that there can be several accumulators with different cell sizes.

In addition, different computing modes are possible to determine (in sub-step E2C) the energy profile of a cell from the intensities of the pixels of the cell.

In particular, in a first embodiment, the energy value of the energy profile, assigned to a cell, is equal to the average of the intensities (or reflectivities) of the pixels of the cell considered. Furthermore, in a second embodiment, the energy value of the energy profile, assigned to a cell, is equal to the sum of the intensities of the pixels in that cell. Other computing modes are also possible.

The processing step E2 thus has the following advantages in particular:
a maximisation of the longitudinal information by sacrificing the transverse axis, which contains little information for elongate objects (in particular ships, which are often symmetrical in the transverse axis). In particular, this will allow a first merge to be implemented in computing step E4, as specified below;
the energy profile (determined in sub-step E2C) will allow the accumulators from each segmentation mask to be calibrated. This will allow for a mapping of the pixels of each measurement in the sequence (implemented in the alignment step E3) and finally for temporal merging of the 3D estimates in merging step E5.

The alignment step E3 which follows the processing step E2 carries out the mapping of the N measurements of the time sequence. It aims to calibrate the energy profiles for all the measurements in the time sequence. It is fundamental for mapping the accumulators and the energy profiles of the moment of the time sequence.

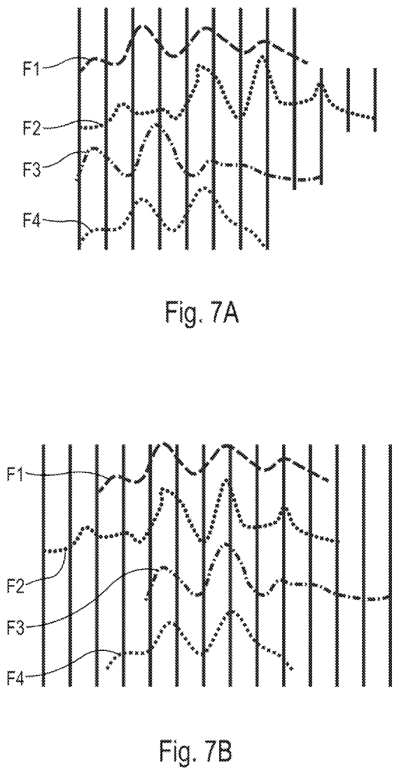

In the example shown in FIG. 7A, four energy profiles F1, F2, F3 and F4 (in this example N=4) are shown. These energy profiles F1 to F4 have been calibrated in the representation in FIG. 7B.

This alignment step E3 provides for a mapping in the image space to obtain a normalisation of the accumulators and energy profiles.

The alignment step E3 provides as many accumulators and energy profiles as there are segmentation masks (and thus measurement points in the time sequence). All the accumulators and the energy profiles provided have the same number of cells and all the cells of a given index correspond to each other (e.g. the cell C3 of an accumulator AC2 (time point 2 of the sequence) describes as closely as possible the pixels of the cell C3 of the accumulator AC1).

Assuming that the longitudinal axis is potentially stretched (or compressed) between the segmentation masks, several samplings and therefore several accumulators and energy profiles per segmentation mask are preferably taken into account.

In a preferred embodiment, the alignment step E3 comprises the following successive sub-steps E3A and E3B, which are implemented for each segmentation mask:
the sub-step E3A consisting in carrying out a correlation of the profile or the profiles to estimate potential translations and optimal samplings; and
the sub-step E3B consisting in carrying out a completion by empty cells and zero energy components of the previous profiles or of the next selected profile according to the sign of the estimated translation.

In sub-step E3A, the profile or the profiles (one or more profiles depending on the number of samplings) are correlated with each other in order to estimate the potential translations and the optimal samplings (if several samplings) between each of them.

An example of processing with a fixed sample value is: close correlation, profile n with profile n+1. The translation index is estimated by looking for the location of the peak in the correlation.

In addition, an example of processing with several sample values is as follows: close correlation, profile n with the M variable sample profiles n+1. Among the M correlations, the selected profile Mj (and thus the sample) is the one with the strongest correlation peak among the M correlation peaks. The translation index is again estimated by the location of the peak in the Mj correlation.

The alignment step E3 has, in particular, the following characteristics and advantages:
the closer the time sequence of acquisition, the more similar the SAR images become and the smaller the differences between the profiles, which ensures a good mapping quality. A time-compact multipath SAR image sequence acquisition is favourable for the mapping. A multipath SAR image sequence with overlapping image integrations can be used to enhance the smooth transition of the profiles between the points in the sequence. In addition, as previously stated for the processing E2B, this prevents accidental reversals of direction between the accumulators;
the processing carried out in the alignment step E3 is fundamental to map the accumulators and the energy profiles of the instants of the sequence;
the choice of a variable sampling allows to compensate for possible compression/dilatation of the SAR signatures (segmentation mask) during the sequence. The number of samplings to be considered is a parameter.

Furthermore, the computing step E4 which follows the alignment step E3 consists, for each of the segmentation masks, in defining a 3D unitary cloud whose number of points is equal to the number of cells of the calibrated accumulator. This processing is the first phase of the merging in 3D space, the second phase being implemented in the merging step E5.

The output consists of N unitary clouds where N is the number of segmentation masks or points in the time sequence (number of multipath images).

The computing step E4 provides, for each segmentation mask, the definition of a 3D cloud whose number of points is equal to the number of cells of the calibrated accumulator.

Furthermore, the computing step E4 comprises the following sequence of successive sub-steps E4A to E4C, which are implemented for each cell (or cloud point) of the calibrated accumulator:
the sub-step E4A consisting in computing the components Xi, Yi and Zi referred to as individual of each of the pixels in the cell;
the sub-step E4B consisting in computing the components X, Y and Z referred to as final of each of the cells, from the assembly of the individual components Xi, Yi and Zi of the cell; and
the sub-step E4C consisting in computing a level component L, based at least on the value of the energy profile F1 to F4 (FIG. 7B) at the cell.

In a preferred embodiment, to compute the level component in a particular embodiment, the sub-step E4C takes into account, in addition to the value of the energy profile at the cell, the quadratic sum of the standard deviations computed over the 3D relocated pixels contained in the cell.

The sub-step E4A consists in computing individual components Xi, Yi and Zi of each of the pixels Pi in the cell Cj of the calibrated accumulator using distance indexes from the sum path SAR image and the estimated angles in the angular maps (geometric relocation). If the cell of the accumulator is empty, the components Xi, Yi and Zi are assigned of a value referred to as “undefined”.

The sub-step E4B consists in defining the terminal components X, Y, Z of the cloud by computing respective statistical averages over Xi, Yi and Zi of the points determined in sub-step E4A.

The sub-step E4C consists in computing the level component L, which is preferably a function of the energy of the cell (value of the energy profile at the cell Cj) and the quadratic sum of the standard deviations X, Y and Z computed on the 3D relocated pixels contained in the cell: L=f(E,\sqrt{σₓ²+σ_{y}²+σ_{z}²}). For example, the level component L can be computed using the following expression: E*\sqrt{σₓ²+σ_{y}²+σ_{z}²}.

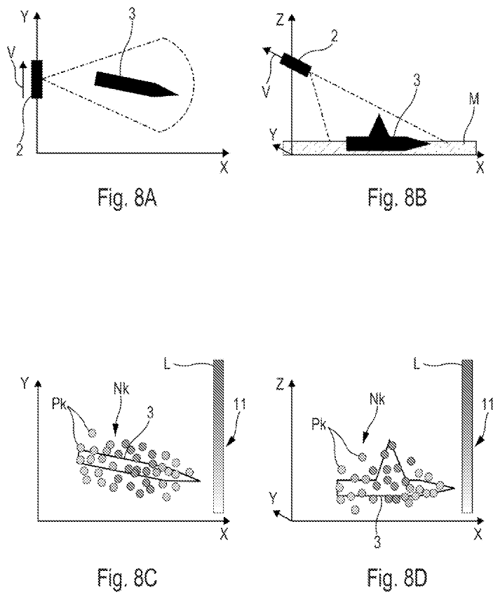

To illustrate the computing step E4, a particular case of a SAR radar 2 moving at a speed V along an axis Y and taking images of an elongate object 3 corresponding to a ship is shown in FIGS. 8A and 8B. FIGS. 8A and 8B show schematic views, respectively, in a horizontal plane XY and in a vertical plane XZ. FIGS. 8C and 8D correspond to FIGS. 8A and 8B respectively and show a unitary 3D cloud, referenced Nk, of points Pk, which is projected onto the elongate object 3 in the XY plane and the XZ plane respectively.

In addition, a scale 11 relative to a level component L is also shown in these FIGS. 8C and 8D.

The grey level of the representation of this scale 11 varies with the value of the level component L. As the value of the level component L increases, so does the corresponding grey level in the representation on the figures. The grey level as represented (in FIGS. 8C and 8D) of the points Pk thus corresponds to the corresponding value of the level component.

This computing step E4, which carries out merging referred to as unitary, allows:
smoothing the radiometric content (energy profile averaged by construction over the cells of the accumulator) over a neighbourhood of the signature, thereby generating a spatial radiometric smoothing; and
smoothing the geometric content (average of the 3D positions in each accumulator cell) over a neighbourhood of the signature, which generates a reduction of the 3D spatial noise induced by the angular noise of the interferometric measurement (itself induced by the thermal noise and the glint effect).

In addition, the choice of the level component L (through a suitable function f) allows the inclusion of a radiometric information supplemented by an information related to the “glint” effect which is an intrinsic property of the object in the measurement (as opposed to the thermal noise which is an extrinsic property of the object).

Furthermore, the purpose of the merging step E5, which follows the computing step E4, is to carry out a terminal merging of the individual clouds to create the final cloud (or optimised 3D cloud). It involves a centring and rotating of the individual clouds and the computing of an average of the components X, Y, Z and L point by point, as described below.

The final cloud (or optimised 3D cloud) is communicated to a user device or system at the end of the merging step E5.

In a preferred embodiment, the merging step E5 comprises in particular successive sub-steps E5A and E5B.

The sub-step E5A, which is implemented for each unitary cloud, comprises the successive sub-steps E5Aa, E5Ab and E5Ac:
the sub-step E5Aa consisting in centring the components X, Y and Z of the unitary cloud (components subtracted from their statistical mean), for example X′=X−m(X);
the sub-step E5Ab consisting in implementing a principal component analysis to estimate the longitudinal axis of the unitary cloud (without taking into account the values of the undefined components of the cloud);
the sub-step E5Ac consisting in generating a rotation of the 3D unitary cloud to orient it along a predefined axis (for example, the orientation of the object with respect to the radar in the middle of the sequence). Any uncertainty of 180° is easily resolved by knowing the first cell and the last cell of the accumulator. The orientation of the 3D cloud is known and mastered.

In addition, the sub-step E5B consists in carrying out the terminal merging which is implemented by computing the statistical average, point by point, of the components X, Y and Z and of the level component L of the assembly of the unitary clouds to obtain said optimised 3D cloud.

The sub-step E5B computes the point-to-point statistical average of the respective components X, Y, Z and L of the clouds, for example at the value i of the component X:

$${X}_{M e r g e} [ i ] = \frac{1}{{N}_{clouds}} {Σ}_{n = 1}^{{N}_{Clouds}} {X}_{n} [ i ] )$$

This merging step E5 allows:
to smooth the radiometric content over a temporal neighbourhood of the signature. Thus, the radiometric content is less fluctuating depending on the aspect angle (as the object is acquired at several aspect angles during the sequence); and
to smooth the geometric content over a temporal neighbourhood of the signature. In this way, a further reduction of the 3D spatial noise induced by the angular noise of the interferometric measurement (itself induced by the thermal noise and the glint effect) is achieved.

In a particular embodiment, the merging step E5 comprises a sub-step E5C of filtering outliers, the smoothing of which is not sufficient, thus allowing to optimise the method PR.

Outliers are considered when the occurrence of undefined values among the components that cause the merging exceeds a fixed threshold. For example, for a threshold of 0.7, if the frequency of occurrence of undefined values in the assembly {[Xₙ[i], Yₙ[i], Zₙ[i], Lₙ[i]], n∈ [symbol] 1, N_{Clouds} [symbol] } exceeds 0.7, the coordinates X(i), Y(i), Z(i) and L(i) of the terminal cloud are deleted (or, in other words, the point i of the cloud is deleted).

The filtering of the outliers thus allows the elimination of the points for which the smoothing is not sufficient (because obtained on a low rate of occurrence).

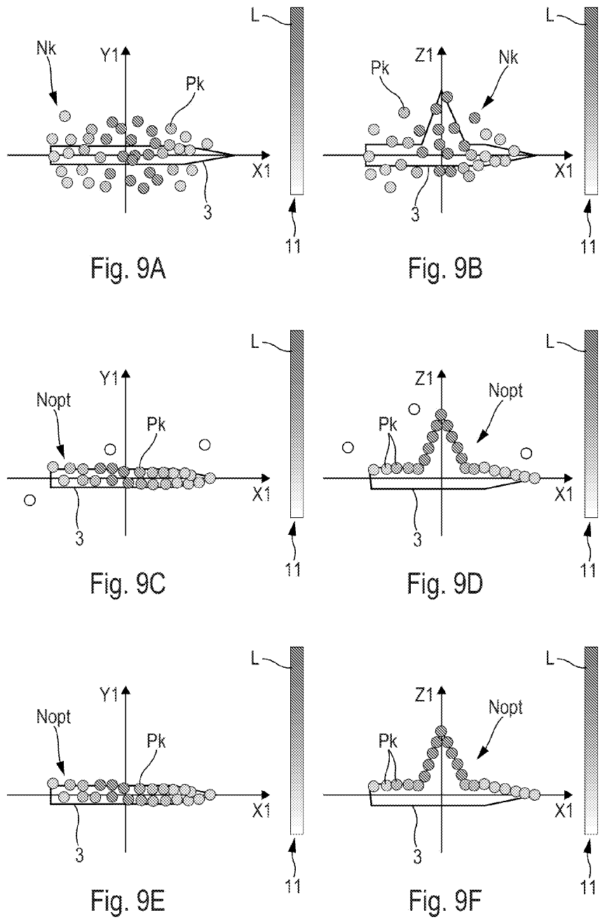

To illustrate the merging step E5, a centred unitary cloud Nk (obtained in sub-step E5A) is shown in FIGS. 9A and 9B. FIGS. 9A and 9B show schematic views, respectively, in a horizontal plane X1Y1 and in a vertical plane X1Z1 positioned with respect to the elongate object 3. FIGS. 9C and 9D correspond to FIGS. 9A and 9B, respectively, and show the optimised 3D cloud Nopt (obtained after the terminal merging carried out in the sub-step E5B). Furthermore, FIGS. 9E and 9F correspond to FIGS. 9C and 9D respectively and show the optimised 3D cloud Nopt after the filtering of the outliers (represented by white circles in FIGS. 9C and 9D). In addition, a scale 11 related to the level component L is also shown in these FIGS. 9A to 9F.

The method PR and/or the device 1, as described above, allow the computing of an optimised 3D cloud of an elongate object 3 from a sequence of SAR images generated by a multipath SAR radar 2. In particular, they have the following characteristics and advantages:
they carry out a radiometric smoothing: the smoothing and the radiometric stability of the 3D cloud, as opposed to the SAR images alone (which are sensitive to the aspect angle), is achieved through:
   the merging on a neighbourhood of the signature (average over the cells of the accumulators) taking into account the elongate hypothesis of the object allowing to sacrifice the transverse axis of the signature; and
   the merging on a temporal neighbourhood of the signature (average over several unitary clouds created at different moments of the acquisition sequence);
they are robust to motion, through the use of the interferometry, as opposed to the SAR images alone (which are blurred and distorted);
they carry out a geometric smoothing. A reduction of the 3D spatial noise caused by the thermal noise and the glint effect is achieved by:
   the use of multipath SAR images which have a better SNR ratio than the native mode of an antenna (distance profiles);
   the segmentation of the upper portion of the signature (segmentation mask) to retain only the points with the best SNR ratio;
   the merging on a neighbourhood of the signature (average over the cells of the accumulators); and
   the merging on a temporal neighbourhood of the signature (average over several unitary clouds created at different times in a temporally contiguous acquisition sequence); and
they can be carried out in a wide variety of different implementations. In particular, they can be implemented:
   with any multipath SAR radar, provided that two azimuth and elevation angles are estimated;
   on any elongate object, and thus in particular on ships; and
   in any type of situation concerning the aiming of the radio axis of the radar, the speed and/or the height of the radar in relation to the object.

The device 1 and/or the method PR, as described above, can be implemented in many applications, in particular (although not exclusively) in the military field.

Two examples of different applications are presented below.

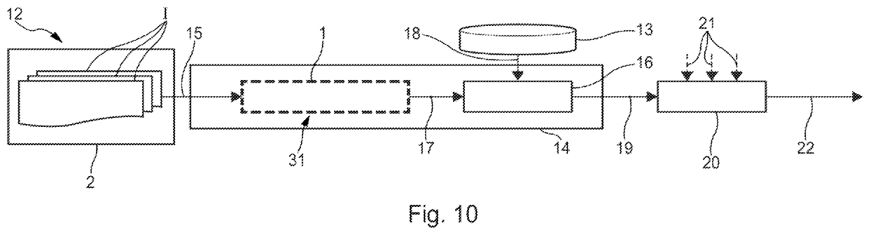

In a first application, said device 1 is part of a system 12, as shown in FIG. 10, for recognising and identifying an elongate target, in particular a ship. Preferably, this system 12 is mounted on board a flying machine, for example a recognition aircraft or a missile such as the missile 4 in FIG. 2, and whose processing are used on board the flying machine.

In this first application, the optimised 3D cloud is to be used as a descriptor in a recognition and identification chain based on comparison with elongate reference objects (in particular ships).

As shown in FIG. 10, said system 12 comprises:
a SAR radar 2 provided with a plurality of paths and capable of generating images I of the environment of an elongate target;
a database 13 containing data referred to as reference of potential targets;
a recognition unit 14 comprising a processing unit 31 comprising said device 1 and incorporating a unit (not shown) such as the unit 5 for carrying out an interferometric processing. The recognition unit 14 is configured to process the images I generated by the SAR radar 2 and received via a link 15, so as to deduce data referred to as detection representing an optimised 3D cloud as described above;
a comparison unit 16 configured to compare this detection data (received via a link 17) with the reference data received from the database 13 via a link 18 so that an elongate target can be recognised and identified.

The processing unit 31 therefore comprises a device 1, as described above, for generating an optimised 3D point cloud depicting the elongate target. This elongate target may correspond to an object to be designated, which is transmitted to a user device (preferably on-board) via a link 19.

Furthermore, in a preferred embodiment, as shown in FIG. 10, the system 12 also comprises a decision unit 20 using the data transmitted by the comparison unit 16 and additional data received via links 21, in particular other data related on a designation, to make a final decision related on a designation of a goal. The decision unit 20 can transmit the result of its processing via a link 22.

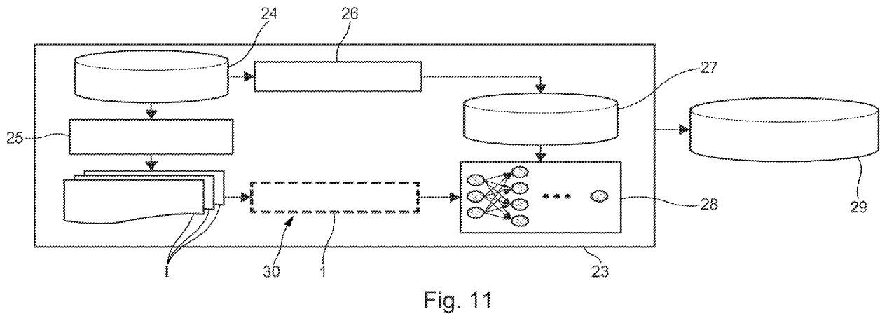

Furthermore, in a second application, said device 1 is part of a system 23, as shown in FIG. 11, for generating a database of targets representing a same type of elongate object, in particular a ship.

In this second application, which is related to a mission preparation in particular, a descriptor computing is used for the creation of the mission preparation entries.

The system 23 comprises, as shown in FIG. 11:
a database 24 comprising CAD models of objects;
a multipath synthetic aperture radar scene generator 25, linked to the database 24 and capable of simulating multipath SAR images (images I);
a processing unit 30 incorporating a unit (not shown) such as the unit 5 for carrying out an interferometric processing and comprising a device 1 as described above. The processing unit 30 is configured to process the images I generated by the generator 25 to generate an optimised 3D point cloud illustrating an elongate object and to provide corresponding data;
a creation unit 26 of a reference base, linked to the database 24 and adapted to create a reference base 27 (e.g. CAD silhouettes); and
a learning unit 28 configured to carry out a learning from the data (e.g. the optimised cloud, or a data that shapes the latter, such as an image recomputed on this cloud) received from the device 1 as well as from the reference base 27, and to provide a trained metric and the reference base. The learning unit 28 carries out the learning of a comparison metric (by Artificial Intelligence) using the descriptors on summary data.

This trained metric (learning) and the reference base can be provided to a unit 29 as mission preparation inputs.

1. A method for generating an optimized 3D point cloud illustrating an elongate object, in particular a ship, from a sequence of images of the environment of the elongate object generated by a synthetic aperture radar provided with a plurality of paths, each of the images referred to as multipath generated by the synthetic aperture radar comprising one synthetic aperture image per path, the multipath images being subjected to an interferometric processing allowing to obtain, for each multipath image, a sum path image and angular maps in azimuth and in elevation,
characterised in that it comprises at least the following steps:
a thresholding step (E1) consisting in carrying out an adaptive thresholding so as to generate a segmentation mask for each of the sum path images;
a processing step (E2) consisting in carrying out, for each of said segmentation masks, an accumulation of measurements so as to generate, for each of said segmentation masks, at least one accumulator and one or more energy profiles;
an alignment step (E3) consisting in calibrating the accumulators and the energy profiles so as to obtain calibrated accumulators and calibrated energy profiles;
a computing step (E4) consisting in computing, for each of said segmentation masks, from the calibrated accumulators and the calibrated energy profiles obtained in the alignment step, a unitary cloud via a unitary merging; and
a merging step (E5) consisting in merging the unitary clouds, so as to obtain said optimised 3D cloud.

2. The method according to claim 1,
characterised in that the thresholding step (E1) comprises:
a sub-step (E1A) consisting in comparing the level of the intensity of each pixel to at least one minimum intensity threshold; and
a sub-step (E1B) consisting in retaining only the pixels whose intensity is greater than this minimum intensity threshold in the segmentation mask which is a binary map of the same size as the sum path image in which the retained pixels are at 1 and the non-retained pixels are at 0.

3. The method according to claim 2,
characterised in that, in the thresholding step (E1), a sub-step (E1C) is also carried out, consisting in carrying out a morphological filtering.

4. The method according to claim 1,
characterised in that the processing step (E2) comprises the following sequence of successive sub-steps (E2A, E2B, E2C), which are implemented for each segmentation mask:
a sub-step (E2A) consisting in implementing a principal component analysis to estimate a length axis of the elongate object, representing a principal axis;
a sub-step (E2B) consisting in computing at least one accumulator sampled along the principal axis, the accumulator representing a one-dimensional grid comprising a plurality of cells, each of said cells containing the pixels of the segmentation mask that are located at the level of the cell; and
a sub-step (E2C) consisting in computing at least one energy profile from the accumulator, the energy profile representing a one-dimensional vector whose values depend on the intensities of the pixels of each of the cells of the accumulator.

5. The method according to claim 1,
characterised in that the alignment step (E3) comprises the following sequence of successive sub-steps (E3A, E3B), which are implemented for each segmentation mask:
a sub-step (E3A) consisting in making a correlation of the profile or profiles to estimate potential translations and optimal sampling; and
a sub-step (E3B) consisting in making a completion with empty cells and zero energy components of previous profiles or of the next profile.

6. The method according to claim 1,
characterised in that the computing step (E4) consists, for each of the segmentation masks, in defining a unitary cloud whose number of points is equal to the number of cells of the calibrated accumulator, and comprises the following sequence of successive sub-steps (E4A, E4B, E4C), which are implemented for each cell of the calibrated accumulator:
a sub-step (E4A) consisting in computing an assembly of components (Xi, Yi, Zi) referred to as individual of each of the pixels in the cell;
a sub-step (E4B) consisting in computing an assembly of components (X, Y, Z) referred to as global for each of the cells, from the assembly of the individual components (Xi, Yi, Zi) of the cell; and
a sub-step (E4C) consisting in computing a level component, based on at least the value of the energy profile at the cell.

7. The method according to claim 6,
characterised in that the computing of the level component takes into account, in addition to the value of the energy profile at the cell, the quadratic sum of the standard deviations computed on the 3D relocated pixels contained in the cell.

8. The method according to claim 1,
characterised in that the merging step (E5) comprises:
a sub-step (E5A) consisting, for each unitary cloud, in carrying out the following operations:
centring the global components of the unitary cloud;
implementing a principal component analysis to estimate the longitudinal axis of the unitary cloud; and
generating a rotation of the unitary cloud to orient it along a predefined axis; and
a sub-step (E5B) consisting in computing the statistical average, point by point, of the global components (X, Y, Z) and of the level component of the assembly of the unitary clouds to obtain said optimised 3D cloud.

9. The method according to claim 8,
characterised in that the merging step (E5) comprises a sub-step (E5C) of filtering outliers.

10. A device for generating an optimized 3D point cloud illustrating an elongate object, in particular a ship, from a sequence of images of the environment of the elongate object generated by a synthetic aperture radar provided with a plurality of paths, each of the images referred to as multipath generated by the synthetic aperture radar comprising a synthetic aperture image per path, the multipath images being subjected to an interferometric processing allowing to obtain, for each multipath image, a sum path image and angular maps in azimuth and in elevation,
characterised in that it comprises at least:
a thresholding unit configured to carry out an adaptive thresholding so as to generate a segmentation mask for each of the images referred to as multipath, each of the multipath images comprising a sum path image and angular maps in azimuth and in elevation;
a processing unit configured to carry out, for each of said segmentation masks, an accumulation of measurements so as to generate, for each of said segmentation masks, at least one accumulator and one or more energy profiles;
an alignment unit configured to calibrate the accumulators and the energy profiles so as to obtain calibrated accumulators and calibrated energy profiles;
a computing unit configured to compute, for each of said segmentation masks, from the calibrated accumulators and the calibrated energy profiles, a unitary cloud (Nk) via a unitary merging; and
a merging unit configured to merge the unitary clouds, so as to obtain said optimised 3D cloud.

11. A system for recognising and identifying a target representing an elongate object, in particular a ship, said system comprising at least:
a synthetic aperture radar provided with a plurality of paths and capable of generating images of the environment of the elongate target;
a processing unit configured to process the images generated by the synthetic aperture radar so as to derive data referred to as detection;
a database containing data referred to as target reference; and
a comparison unit configured to compare the detection data with the reference data in the database so as to be able to recognise and identify an elongate target,
characterised in that the processing unit comprises a device as specified in claim 10 and a unit carrying out an interferometric processing.

12. The system according to claim 11,
characterised in that it comprises a decision unit using the identification data of an elongate target transmitted by the comparison unit and additional data to make a goal designation decision.

13. A system for generating a trained metric and a reference base related to at least one type of elongate object, in particular a ship, said system comprising at least:
a base of object models, and at least of elongate objects;
a multipath synthetic aperture radar scene generator linked to the object model base and capable of simulating multipath SAR images;
a processing unit configured to process the images generated by the scene generator to create a point cloud depicting an elongate object and provide data;
a creation unit for creating a reference base, linked to the object model base and adapted to create a reference base; and
a learning unit configured to carry out a learning from the data received from the processing unit and from the reference base and to provide the trained metric and the reference base,
characterised in that the processing unit comprises a device as specified in claim 10 and a unit carrying out an interferometric processing beforehand.
